(19) United States
(12) Patent Application Publication
(10) Pub. No.: US 2004/0221228 A1
(43) Pub. Date: Nov. 4, 2004

(54) Method and apparatus for domain specialization in a document type definition

(75) Inventors: Don Rutledge Day, Austin, TX (US); Erik Frederick Hennum, San Francisco, CA (US); Michael F. Priestley, Toronto (CA)

Correspondence Address: IBM CORP (YA), C/O YEE & ASSOCIATES PC, P.O. BOX 802333, DALLAS, TX, 75380, US

(73) Assignee: International Business Machines Corporation, Armonk, NY

(21) Appl. No.: 10/427,095

(22) Filed: Apr. 30, 2003

(51) Int. Cl. G06F 15/00

(52) U.S. Cl. 715/513

(57) ABSTRACT

A method and apparatus for domain specialization of document type definitions (DTDs) are provided. With the method and apparatus, a user may define a domain specialized DTD using specialized DTD elements derived from base DTD elements that are supported by a community of users. The specialized DTD for the domain is created by defining new elements that have a formal relationship with the base DTD elements. A shell DTD is created that references the base DTD elements and the specialized DTD elements. The shell DTD redefines the entity associated with the base DTD element to add the specialized DTD element. The shell DTD further includes a domain list that identifies all of the domains associated with the shell DTD. Since the shell DTD associates the entity with both the base DTD element and the specialized DTD element, and because content models reference elements by the use of the entity to reference the corresponding element, the specialized element may be used anywhere that the general element may be used.

### BACKGROUND OF THE INVENTION

1. Technical Field

The present invention is directed to a method and apparatus for domain specialization in a document type definition.

2. Description of Related Art

The purpose of a Document Type Definition (DTD) is to define the legal building blocks of an extensible Markup Language (XML) or HyperText Markup Language (HTML) document. It defines the document structure with a list of legal elements. DTDs define the structure of a corresponding XML or HTML document. Independent groups of people can agree to use a standard DTD to facilitate the exchange of data. Moreover, an application may be configured to use a standard DTD to verify data that is received by the application. Thus, DTDs provide a mechanism by which a group of users and/or applications agree on the structure of data being exchanged by the group of users/applications.

From a DTD point of view, every XML or HTML document is comprised of the same basic building blocks: elements, tags, attributes, entities, PCDATA and CDATA. Elements are the main building blocks of both XML and HTML documents. Examples of HTML elements are “body” and “table”. Examples of XML elements are “note” and “message”. Elements can contain text, other elements, or be empty. Examples of empty HTML elements are “hr”, “br” and “img”.

Tags are used to markup elements. A starting tag like <element_name> marks up the beginning of an element, and an ending tag like </element_name> marks up the end of an element. Examples include “<body>body text in between</body>” and “<message>some message in between</message>.”

Attributes provide extra information about elements. Attributes are placed inside the starting tag of an element. Attributes come in name/value pairs. The following “img” element has additional information about a source file: <img src=“computer.gif”/>. The name of the element is “img”. The name of the attribute is “src”. The value of the attribute is “computer.gif”. Since the element itself is empty it is closed by a “/”.

Entities are variables used to define common text. Entity references are references to entities. Entities are expanded when a document is parsed by an XML or HTML parser.

PCDATA means parsed character data. The character data as the text found between the start tag and the end tag of an XML element. PCDATA is text that will be parsed by a parser. Tags inside the text will be treated as markup and entities will be expanded.

CDATA also means character data. CDATA is text that will NOT be parsed by a parser. Tags inside the text will not be treated as markup and entities will not be expanded.

A DTD uses each of these building blocks to define the structure of a document so that those users and/or applications receiving the document may know the structure in order to properly process the document. That is, by knowing the structure of the document, the applications will know how to process and display the information in the document. This is especially true when the DTD is accepted by a group of users and developers as a standard DTD that is to be supported within their community. In this way, each member of the community will know what document structures they can expect to receive from other members of the community and what document structures they can use to communicate information to other members of the community.

Often times, however, there are subcommunities of users and developers that have specific usage requirements for these DTDs. That is, a large community of users and developers may include a software subcommunity, a hardware subcommunity, and the like. The software subcommunity and hardware subcommunity may each decide to use different DTDs within their subcommunity. As a result, each subcommunity may generate documents based on DTDs that are not supported by the other subcommunities. This may make it difficult for such documents to be processed by applications of other subcommunities.

Furthermore, if a subcommunity wishes its DTDs to be supported by other subcommunities, it must petition the community as a whole to adopt the new DTD. This takes considerable time and effort resulting in a period of time in which documents are being created using the subcommunity's DTD but not being able to provide those documents to other subcommunities because the DTD is not supported.

Thus, it would be beneficial to have an apparatus and method that allows users to define their own specialized DTDs and DTD elements based on standard DTDs and DTD elements. It would further be beneficial to define such specialized DTDs and DTD elements in such a way that they may be supported by the entire community through generalization to the standard DTDs and DTD elements.

### SUMMARY

A method and apparatus for domain specialization of document type definitions are provided. With the method and apparatus, document type definitions are defined with entities and elements. An entity is a variable used to reference an element and an element is a basic building block of a document type definition (DTD).

With the preferred embodiment, a user may define a domain specialized DTD using specialized DTD elements derived from base DTD elements that are supported by a community of users and applications. The specialized DTD for the domain is created by defining new elements that have a formal relationship with the base DTD elements. The new elements are made usable in the same positions as their corresponding base elements by adding the new element to an entity associated with each base element. A shell DTD is created that encapsulates the base DTD elements and the specialized DTD elements. The shell DTD defines the entity associated with the base DTD element and augmented by the specialized DTD element. The shell DTD further includes a domain list that identifies all of the domains associated with the shell DTD.

Since the shell DTD redefines the entity for the base DTD element and because content models reference elements by the use of the entity, the specialized element may be used anywhere that the general element may be used.

Furthermore, the specialized DTD element may be generalized to the base DTD element. The specialized elements in the specialized DTD contain an ancestry attribute that identifies the domains and base DTD elements from which they are descended. In this way, if a domain specialized content model is received by an application that does not support the domain, the specialization can be generalized to a parent domain in the ancestry that is supported by the application. In this way, the specialized DTD element will be processed as if it were a base DTD element supported by the application. This generalization can be performed either by interpreting the specialized element as the base element during processing or by preprocessing the document to revert the specialized elements to base elements before processing.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. However, the preferred mode of use, further objectives and advantages thereof, will best be understood by reference to the following detailed description of an illustrative embodiment when read in conjunction with the accompanying drawings, wherein;

FIG. 1 is an exemplary diagram of a distributed data processing system;

FIG. 2 is an exemplary block diagram of a server computing device;

FIG. 3 is an exemplary block diagram of a client computing device;

FIG. 4 is an exemplary diagram illustrating the formal relationships created and used in an illustrative embodiment;

FIG. 5 is an exemplary diagram illustrating a domain specialize DTD generated used in an illustrative embodiment;

FIG. 6 is an exemplary block diagram illustrating the relationship between a domain specialized DTD and the base and specialized domains;

FIG. 7 is a flowchart outlining an exemplary operation of an illustrative embodiment when generating a base elements module for use in creating a domain specialized document type definition;

FIG. 8 is a flowchart outlining an exemplary operation of an illustrative embodiment when generating a specialized elements module for use in creating a domain specialized document type definition;

FIG. 9 is a flowchart outlining an exemplary operation of an illustrative embodiment when generating a domain specialized document type definition (DTD) data structure; and

FIG. 10 is a flowchart outlining an exemplary operation of an application when generalizing an entity reference in a content model based on a domain specialized DTD.

### DETAILED DESCRIPTION OF THE PREFERRED EMBODIMENT

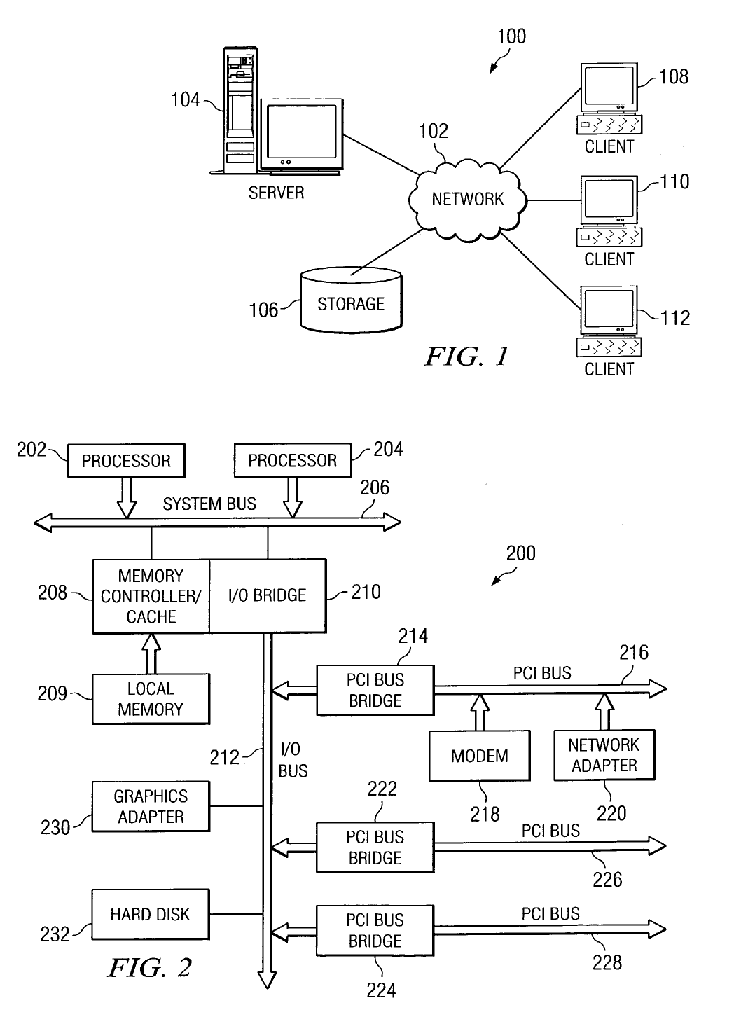

The preferred embodiment provides a mechanism for providing domain specialization of document type definitions. As such, the mechanisms of the preferred embdoiment may be implemented in a distributed data processing environment or a stand alone computing system. In a preferred embodiment, the present invention is implemented in a distributed data processing environment in which a Document Type Definition (DTD) server provides support for various standard DTDs supported by a community of users and application providers. In order to provide a context for the execution environment of the preferred embodiment, FIGS. 1-3 are provided to describe a simplified representation of a distributed data processing environment in which the preferred embodiment may be implemented.

With reference now to the figures, FIG. 1 depicts a pictorial representation of a network of data processing systems in which the preferred embodiment may be implemented. Network data processing system 100 is a network of computers in which the preferred embodiment may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

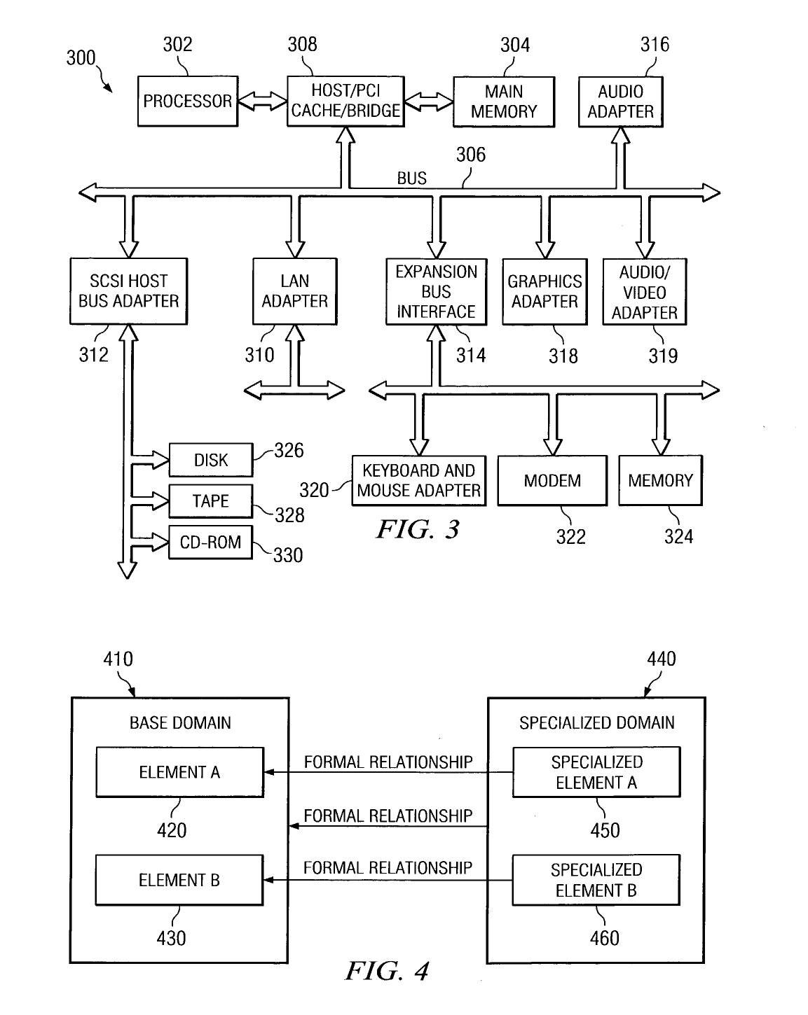

With reference now to FIG. 3, a block diagram illustrating a data processing system is depicted in which the preferred embodiment may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM) equivalent nonvolatile memory, or optical disk drives and the like, may be used in addition to or in place of the hardware depicted in FIG. 3. Also, the processes of the preferred embodiment may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As mentioned previously, the preferred embodiment provides a mechanism by which users may design their own specialized DTD elements for defining the structure of documents based on standard DTD elements with a formal relationship being provided between the specialized DTD elements and the standard DTD elements. This formal relationship allows documents structured using the specialized DTD elements to be received and processed by applications that do not necessarily support the specialized DTD elements. In such a case, the application will treat the document as being structured in accordance with the standard DTD elements.

The term “standard” DTD element as it is used in the present description refers to a DTD element that has already been determined to be supported by a community of users/developers. Examples of standard DTDs having standard DTD elements include IBMIDDoc, DocBook, TEI, XHTML, and the like. The preferred embodiment regards the standard DTD elements as a module of base DTD elements from which a module of specialized DTD elements can be derived. A specialized DTD element is a variation of a standard DTD element with more meaning within a specific subject area, e.g., application software, hardware, user interface, etc.

The preferred embodiments of the present invention make use of the Darwin Information Typing Architecture (DITA), available from International Business Machines (IBM), Inc., which is an XML-based architecture for authoring, producing and delivering technical information. Although DITA is used in the preferred embodiments of the present invention, it should be appreciated that the present invention is not limited to such and any document type definition based architecture for authoring, producing and delivering technical information may be used without departing the spirit and scope of the present invention. All that is required is that a mechanism for establishing a formal relationship between base DTD elements and specialized DTD elements be provided such that the specialized DTD elements may be used anywhere that the base DTD elements are used in content models.

The DITA architecture includes a set of design principles for creating “information-typed” modules at a topic level. A topic in DITA is a unit of information that describes a single task, concept, or reference item. The topic is the basic unit of processable content within the DITA architecture and acts as a DTD for the content. A topic provides the title, metadata, and structure for the content. Some topic types provide very simple content structures while others provide more complex structures. For example, the “concept” topic has a single concept body for all of the concept content. By contrast, the “task” topic articulates a structure that distinguishes pieces of the task content, such as the prerequisites, steps, and results.

In most cases, these topic structures contain content elements that are not specific to the topic type. For example, both the concept body and the task prerequisites permit common block elements such as “p” paragraphs and “ul” unordered lists.

With the preferred embodiment, these general content elements are extensible through domain specialization. By “domain specialization” what is meant is that general content elements may be customized for use in a particular subject area by defining new types of content elements. For example, through domain specialization, new phrase or block elements of a topic DTD may be created from existing phrase and block elements. The specialized content elements may be used within any topic structure where its base element is allowed. For example, because a “p” paragraph can appear within a concept body or task prerequisite, a specialized paragraph could appear there as well. This allows individual subcommunities of users to generate their own special content elements and still be able to use them with existing topics.

A DITA domain is a collection of specialized content elements used for a specific purpose. That is, a domain is a collection of content elements that have been specialized in accordance with the preferred embodiment based on a base content element. Examples of domains and their purpose are set forth below:

| Domain | Purpose |
|---|---|
| highlight | To highlight text with |
| | styles such as bold, italic |
| | and monospace |
| programming | To define the syntax and |
| | give examples of |
| | programming languages |
| Software | To describe the operation |
| | of a software program |
| UI | To describe the user |
| | interface of a program |

For most domains, specialized content elements add semantics to a base content element. For example, the apiname element of the programming domain extends the basic keyword element with the semantic of a name within an application program interface (API). The preferred embodiment provides a mechanism for deriving these specialized content elements based on base content elements of a topic and allows for a formal relationship to be maintained between the specialized content elements and the base content elements.

That is, as shown in FIG. 4, specialized content elements 450 and 460 for specialized domain 440 are derived, by the mechanisms of the preferred embodiment, based on the base content elements 420 and 430 from base domain 410. The preferred embodiment provides data structures for establishing a formal relationship between the specialized elements 450-460 and their corresponding base elements 420-430. In addition, a formal relationship is provided between the domains 410 and 440. Based on these formal relationships, the specialized elements 450-460 can be used in content models anywhere where the base elements 420-430 may be used. Also, based on the formal relationship between the base domain 410 and the specialized domain 440, applications that do not support the specialized elements 450-460 of the specialized domain 440 will treat these elements 450-460 as if they were the base elements 420-430.

In a preferred embodiment, the formal relationships are provided by defining an entity to represent a base content element and a specialized content element derived from the base element, and by providing a domain specialization ancestry attribute that defines the relationship between the specialized element and the base element.

A topic DTD is a shell having attributes, entities, and references to modules in which the elements are actually defined. These elements provide building blocks to create new combinations of topic types and domains. The preferred embodiment essentially includes placing base content elements in a base module, placing the specialized content elements in a domain module, and creating a topic DTD shell that includes the base module and the domain module. The details of each of these operations are provided hereafter.

In order to generate a domain specialized topic DTD for use in creating information content, the preferred embodiment starts by defining a base content elements module. That is, a base elements module is created with an entity defined to represent a list of domains used in the document type of the base elements module. The entity is set to a default value that is an empty string:

<!ENTITY included-domains “”>

An entity is then declared for each base element to reference the base element. This entity will represent both the base element and any domain specializations of the base element in content models. The default value of the entity is the name of the base element. For example, the entity:

<!ENTITY % ph “ph”>

declares an entity ph that references a paragraph element that has a default value of “ph”, i.e. the name of the base element “ph.” This process is repeated for each element of the base element module.

Each element of the base element module is then defined with a class attribute that states the specialization ancestry. For a base element, the specialization ancestry consists of the element itself. For example, the ph element described above may be defined as:

<!ELEMENT ph (#PCDATA)*>
<!ATTLIST ph class CDATA “+ topic/ph”>

The attribute list ATTLIST identifies the ph element as having a class attribute indicating that the ph element is an element of the topic domain. The topic domain is the top domain in the hierarchy of domains and thus, by defining the ancestry to include only the topic domain, it is clear that this is a base element. This process is repeated for each element of the base element module.

The definition of each content model uses entities to identify the appropriate elements instead of the literal element name. For example, the content model for a paragraph would identify the ph element by means of the %ph; entity:

<!ELEMENT p ( #PCDATA | %ph; )*>

Because the content model uses entities to identify appropriate elements, if the specialized element is also set to be referenced by the same entity, then the specialized element may be used anywhere that the base element could be used in a content model, assuming that the receiving application supports the specialized domain. As a result, through the use of common entities, specialized domains may be used with existing content models.

Thus, with the preferred embodiment, a base element module is created by defining an entity to identify a list of domains, defining one or more entities to reference corresponding elements of the base element module, defining the elements that are to be included in the base element module using entities to identify elements in their content models, and then defining the specialization ancestry class attributes for each element. These entities and attributes are set to default values in the base element module.

Next, a specialized elements module is created in a similar manner as the base elements module. For instance, an entity and a class attribute are defined for each element. However, the class attribute identifies both the base element and its domain and the specialized element and its domain. For example, a specialized element is defined in the specialized elements module as:

<!ELEMENT b(#PCDATA)*>
<!ATTLIST b class CDATA “+ topic/ph hi-d/b”>

where topic/ph is the ph (phrase) element in the topic domain, i.e. the base domain, and hi-d/b is the b (bold) element in the hi-d (highlight) domain. In this way, the ancestry of the b element defines a formal relationship between it and the ph element of the base domain.

Once the base elements module and the specialized elements module are generated, a document type definition (DTD) shell for the specialized domain is created. The DTD shell includes a declaration of the domain list entity that overrides the domain list entities in the base element module. The domain list entity in the DTD shell is set to the value of the specialized domain. For example, the entity is declared in the DTD shell as:

<!ENTITY included-domains “(topic hi-d)”>

This domain list entity provides a formal declaration for the domains used by the documents created with the DTD shell. As will be described hereafter, this domain list entity, along with the ancestry class attribute of the elements in the specialized elements module, allows for generalization of specialized elements of the DTD shell so that applications that do not support the specialized elements may treat the specialized elements as base elements.

The DTD shell further includes entities for each element of the base element module that are being extended by the specialized element module. These entities correspond to the entities declared in the base element module but have their values redefined to both the base element and its corresponding specialized element. Thus, for example, the entity ph may be declared in the DTD shell as:

<!ENTITY % ph “ph|b”>

The declaration of the entity in the DTD shell to have a value that references both the base element and the specialized element makes the specialized element a synonym for the base element. In this way, the entity ph may be used in content models anywhere that the ph element may be used.

Once the domain list entity and element entities are defined in the DTD shell, the domains attribute of the topic elements of the DTD shell are defined to declare the domains represent in the corresponding document. The domains attribute identifies the domains available within a topic. The domains attribute should identify the domains included in the domain list associated with the domain list entity. The base elements are then defined for the DTD shell. This involves including a reference to the base elements module such as:

<!ENTITY % topic-type PUBLIC “-//IBM//ELEMENTS DITA
Topic//EN” “topic.mod”>
%topic-type;

The specialized elements are then defined for the DTD shell. This involves including a reference to the specialized elements module such as:

<!ENTITY % hi-d-def PUBLIC “-//IBM//ELEMENTS DITA
Highlight Domain//EN” “highlight-domain.mod”>
%hi-d-def;

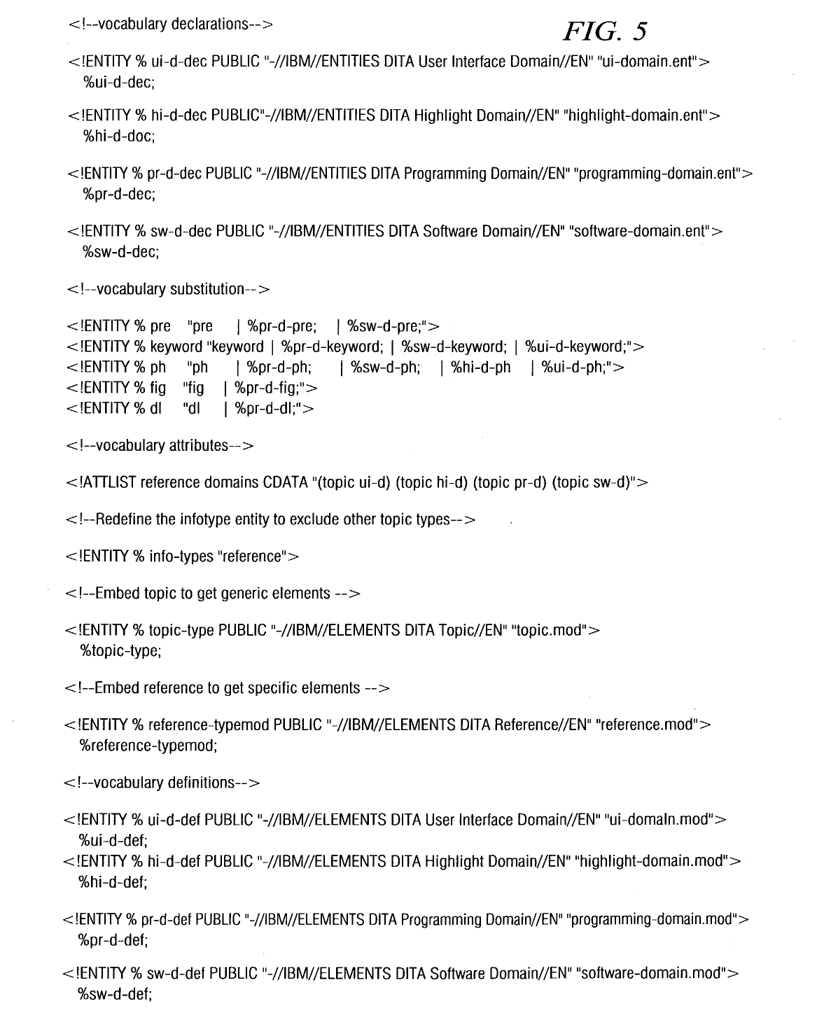

As a result of the above, the DTD shell is populated by the preferred embodiment to include a declaration of the domains used by topics of the DTD, a definition of the entities associating base elements and specialized elements, a reference to the base elements module, and a reference to the specialized elements module. The result is a domain specialized DTD that may be used to create documents, using the specialized elements but also being compatible with applications that do not support the specializations. An example of a domain specialized DTD generated using the preferred embodiment is illustrated in FIG. 5. For example, using the domain specialized DTD created through the above process, a user may create content within a paragraph that includes not only the ph element of the base DTD but the b element as well. However, if the application receiving the document does not support the specialized element “b”, the specialized element “b” can be interpreted as the base element “ph” of the base domain “topic”.

Stated another way, because the base element is guaranteed to be valid anywhere the specialized element is used, and because the base element is guaranteed to support the content of the specialized element, a processor can automatically convert the specialized element to the base element, either for processing specific to the base element or to retire the specialized element. The processor can use the class attribute to discover the base element. Through use of the domain list attribute, the processor can also distinguish two elements with the same name from different domains.

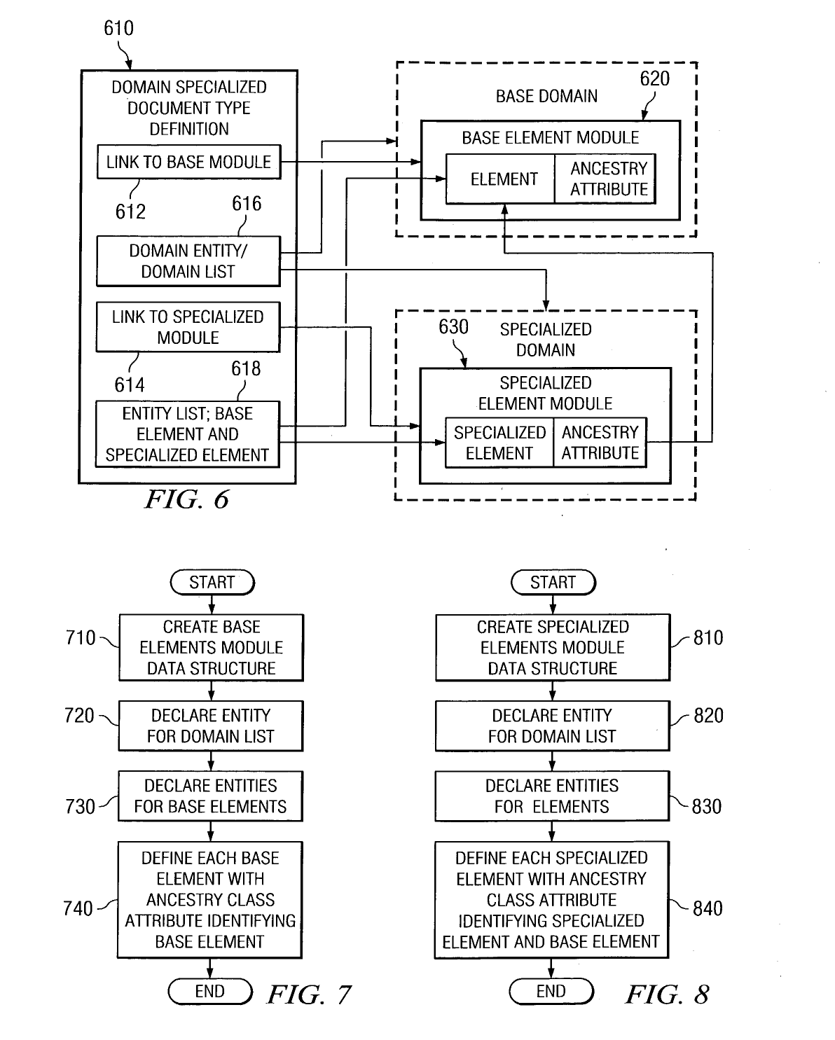

As illustrated in FIG. 6, the domain specialized DTD 610 which is created using the process described above, includes a reference 612 to the base elements module, a reference 614 to the specialized elements module, a domain entity/domain list 616 identifying the domains supported by the domain specialized DTD 610, and an entity list 618 identifying the entities associated with the base elements and specialized elements.

As illustrated by the arrows in FIG. 6, the reference 612 may be utilized by an application receiving the domain specialized DTD 610 and a corresponding document (not shown) to identify the elements in the base element module used in the document. The reference 614 may be utilized by an application receiving the domain specialized DTD 610 and a corresponding document to identify the elements in the specialized element module used in the document, if the application supports the domain specialization.

The domain entities/domain list 616 may be utilized to distinguish between elements that have the same names but are in different domains. The entity list 618 is interpreted by standard XML processors to permit the specialized element where the base element appears in a content model. As shown in FIG. 6, each entity in the entity list references both a base element in the base element module 620 of the base domain and a specialized element in the specialized element module 630 of the specialized domain.

The specialized elements in the specialized element module 630 include an ancestry attribute that identifies their associated base elements in the base element domain. In this way, if an application receiving the domain specialized DTD 610, and a corresponding document, does not support the domain specialization, the corresponding entity in the entity list 618 and the ancestry attribute for the specialized element may be used to generalize the specialized element by pinpointing the base element in the base element module 620 from which the specialized element was generated. This base element is valid everywhere that the specialized element is valid and thus, the application may interpret the element in the document content to be the base element rather than the specialized element.

FIGS. 7-10 are flowcharts that illustrate the creation of a base elements module, a specialized elements module, a domain specialized DTD, and the processing of an entity in a content model based on the domain specialized DTD according to the preferred embodiment. It will be understood that each block of the flowchart illustrations, and combinations of blocks in the flowchart illustrations, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustrations support combinations of means for performing the specified functions, combinations of steps for performing the specified functions and program instruction means for performing the specified functions. It will also be understood that each block of the flowchart illustrations, and combinations of blocks in the flowchart illustrations, can be implemented by special purpose hardware-based computer systems which perform the specified functions or steps, or by combinations of special purpose hardware and computer instructions.

FIG. 7 is a flowchart outlining an exemplary operation of the preferred embodiment when generating a base elements module for use in creating a domain specialized document type definition. As shown in FIG. 7, the operation starts by creating a base elements module data structure (step 710). An entity is declared in the base elements module to represent the list of domains used in the document type (step 720) and entities for each base element are declared in the base elements module to represent these base elements (step 730). Each base element is then defined within the base elements module with a specialization ancestry class attribute that is set to the base element and domain (step 740). The operation then terminates.

FIG. 8 is a flowchart outlining an exemplary operation of the preferred embodiment when generating a specialized elements module for use in creating a domain specialized document type definition. As shown in FIG. 8, the operation starts by creating a specialized elements module data structure (step 810). The same entity as was declared in the base elements module to represent the list of domains used in the document type is also declared in the specialized elements module (step 820). The same entities declared for each base element are also declared in the specialized elements module, however their values are set to the specialized elements (step 830). Each specialized element is then defined within the specialized elements module with a specialization ancestry class attribute that identifies both the specialization element and domain and the base element and domain (step 840). The operation then terminates.

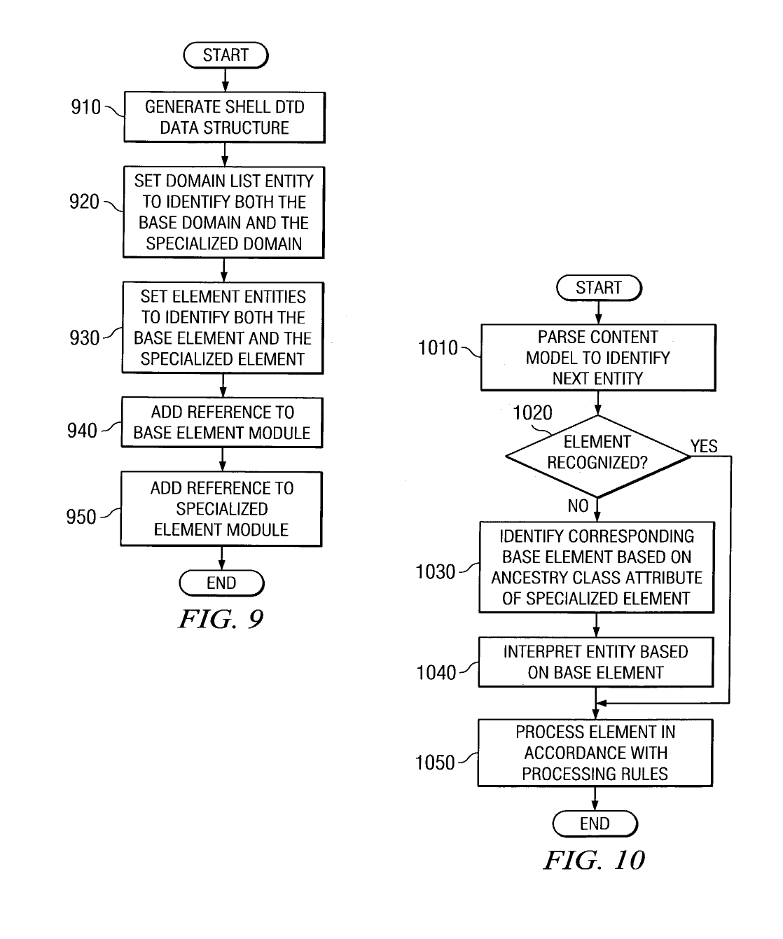

FIG. 9 is a flowchart outlining an exemplary operation of the preferred embodiment when generating a domain specialized document type definition (DTD) data structure. As shown in FIG. 9, a shell DTD data structure is generated (step 910). The domain list entity is set to identify both the base domain and the specialized domain (step 920). The element entities in the shell DTD are set to identify both the base element and the specialized element generated from the base element (step 930). This may be determined by looking at the elements in the base element module and the specialized element module to identify which elements use the same entity reference.

Thereafter, a reference to the base elements module is added (step 940). A reference to the specialized elements module is also added (step 950)- The operation then terminates.

FIG. 10 is a flowchart outlining an exemplary operation of an application when reading documents based on a domain specialized DTD. As shown in FIG. 10, the operation starts by parsing the document and encountering an element that needs to be processed (step 1010). A determination is made as to whether this element is recognized (step 1020). If so, the element is processed by the application in accordance with processing rules (step 1050). If the specialized element is not recognized, the ancestry attribute of the specialized element is used to identify the base element corresponding to the specialized element (step 1030). The operation then interprets the entity based on the base element (step 1040) and processes the base element in accordance with processing rules (step 1050). This process may be repeated for each element encountered in the document.

Thus, the preferred embodiment provides a mechanism by which domain specialized DTDs may be derived using specialized DTD elements having formal relationships with base elements from which they are generated. With the preferred embodiment, the specialized elements may be used in the same context as the base elements. This allows for generalization of the specialized elements in the event that the recipient of the domain specialized DTD does not support the domain specialization.

It is important to note that while the preferred embodiment has been described in the context of a fully functioning data processing system, those of ordinary skill in the art will appreciate that the processes of the preferred embodiment are capable of being distributed in the form of a computer readable medium of instructions and a variety of forms and that the preferred embodiment applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the preferred embodiment has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a computing device, for deriving a domain specialized document type definition data structure, comprising:
creating a base element module data structure that defines a base element of the document type definition;
creating a specialized element module data structure that defines a specialized element of the document type definition that is a variation of the base element in the base element module data structure; and
creating a domain specialized document type definition data structure that references the base element module data structure and the specialized element module data structure such that corresponding the base element and the specialized element are associated with a same element reference.

2. The method of claim 1, wherein the specialized element includes an ancestry attribute that identifies a formal relationship with the base element in the base element module data structure.

3. The method of claim 1, wherein the domain specialized document type definition data structure includes a reference to a base domain associated with the base element module data structure and a specialized domain associated with the specialized element module data structure.

4. The method of claim 3, wherein the reference to the base domain and the specialized domain is used by an application to interpret a content model when the specialized domain is not supported by the application.

5. The method of claim 1, wherein the domain specialized document type definition data structure is associated with a content model, and wherein the content model includes the element reference.

6. The method of claim 1, wherein the base element module data structure stores information pertaining to a plurality of base elements of a topic document type data structure in a Darwin Information Typing Architecture.

7. The method of claim 1, wherein creating a base element module data structure includes:
creating a first entity for representing a list of domains used in a document type of the base element module data structure;
creating a second entity for the base element to reference the base element; and
creating a base element definition, wherein the base element definition includes a specialization ancestry attribute that identifies the base element.

8. The method of claim 7, wherein creating the specialized element module data structure includes:
associating the specialized element with the second entity; and
creating a specialized element definition, wherein the specialized element definition includes a specialization ancestry attribute that identifies both the specialized element and the base element.

9. The method of claim 1, wherein the domain specialized document type definition data structure includes an entity for each base element defined in the base element module data structure that is extended by a specialized element in the specialized element module data structure, wherein the entity references both the base element and the corresponding specialized element.

10. The method of claim 5, wherein the content model is processed by an application and wherein processing of the element reference includes:
determining if a specialized element associated with the element reference is recognized by the application; and
interpreting the element reference to reference an associated base element if the specialized element is not recognized by the application.

11. A computer program product in a computer readable medium for deriving a domain specialized document type definition data structure, comprising:
first instructions for creating a base element module data structure that defines a base element of the document type definition;
second instructions for creating a specialized element module data structure that defines a specialized element of the document type definition that is a variation of the base element in the base element module data structure; and
third instructions for creating a domain specialized document type definition data structure that references the base element module data structure and the specialized element module data structure such that corresponding the base element and the specialized element are associated with a same element reference.

12. The computer program product of claim 11, wherein the specialized element includes an ancestry attribute that identifies a formal relationship with the base element in the base element module data structure.

13. The computer program product of claim 11, wherein the domain specialized document type definition data structure includes a reference to a base domain associated with the base element module data structure and a specialized domain associated with the specialized element module data structure.

14. The computer program product of claim 13, wherein the reference to the base domain and the specialized domain is used by an application to interpret a content model when the specialized domain is not supported by the application.

15. The computer program product of claim 11, wherein the domain specialized document type definition data structure is associated with a content model, and wherein the content model includes the element reference.

16. The computer program product of claim 11, wherein the base element module data structure stores information pertaining to a plurality of base elements of a topic document type data structure in a Darwin Information Typing Architecture.

17. The computer program product of claim 11, wherein the first instructions for creating a base element module data structure include:
instructions for creating a first entity for representing a list of domains used in a document type of the base element module data structure;
instructions for creating a second entity for the base element to reference the base element; and
instructions for creating a base element definition, wherein the base element definition includes a specialization ancestry attribute that identifies the base element.

18. The computer program product of claim 17, wherein the second instructions for creating the specialized element module data structure include:
instructions for associating the specialized element with the second entity; and
instructions for creating a specialized element definition, wherein the specialized element definition includes a specialization ancestry attribute that identifies both the specialized element and the base element.

19. The computer program product of claim 11, wherein the domain specialized document type definition data structure includes an entity for each base element defined in the base element module data structure that is extended by a specialized element in the specialized element module data structure, wherein the entity references both the base element and the corresponding specialized element.

20. The computer program product of claim 15, wherein the content model is processed by an application and wherein processing of the element reference includes:
instructions for determining if a specialized element associated with the element reference is recognized by the application; and
instructions for interpreting the element reference to reference an associated base element if the specialized element is not recognized by the application.

21. An apparatus for deriving a domain specialized document type definition data structure, comprising:
means for creating a base element module data structure that defines a base element of the document type definition;
means for creating a specialized element module data structure that defines a specialized element of the document type definition that is a variation of the base element in the base element module data structure; and
means for creating a domain specialized document type definition data structure that references the base element module data structure and the specialized element module data structure such that corresponding the base element and the specialized element are associated with a same element reference.
